(19) United States
(12) Patent Application Publication
(10) Pub. No.: US 2025/0258861 A1
(43) Pub. Date: Aug. 14, 2025

(54) TILE-BASED IMAGE UNDERSTANDING IN VISION AND LANGUAGE MODELS

(71) Applicant: GOOGLE LLC, Mountain View, CA (US)

(72) Inventors: Khalid Salama, Zurich (CH); Arkadiusz Socala, Zurich (CH)

(21) Appl. No.: 18/439,322

(22) Filed: Feb. 12, 2024

(51) Int. Cl. G06F 16/532; G06F 16/538; G06F 40/40; G06V 10/764

(52) U.S. Cl. CPC G06F 16/532; G06F 16/538; G06F 40/40; G06V 10/764

(57) ABSTRACT

Implementations disclosed herein are directed to at least responding to an input query comprising a natural language query and an image using a vision and language model (VLM). The input NL query and image are processed to generate sub-images (referred to herein as “tiles”) of the input image that are relevant to the NL query. The tiles are processed by one or more image analysis models, such as image search engines, to generate image facts that relate to the tiles, e.g., the contents of a tile, identities of objects/people in the tile, or the like. The VLM processes the image tiles, the NL query, and the image facts to generate a response to the input query. The response is rendered at a client device.

### BACKGROUND

Various generative models have been proposed that can be used to process natural language (NL) content and/or other input(s), to generate output that reflects generative content that is responsive to the input(s). For example, large language models (LLM(s)) have been developed that can be used to process NL content and/or other input(s), to generate LLM output that reflects NL content and/or other content that is responsive to the input(s). For instance, an LLM can be used to process NL content of “how to change DNS settings on Acme router”, to generate LLM output that reflects several responsive NL sentences such as: “First, type the router's IP address in a browser, the default IP address is 192.168.1.1. Then enter username and password, the defaults are admin and admin. Finally, select the advanced settings tab and find the DNS settings section”. Vision and language models (VLMs) extend LLM capabilities to include the ability to receive images as input in addition to, or as an alternative to, NL input. However, current utilizations of generative models suffer from one or more drawbacks.

As one example, VLMs can be utilized as part of a text-based dialogue application, generating responses to queries that comprise images provided by a user of the application. However, not all of an input image may be relevant to a user query, for example if the query is directed towards a subset of the objects captured in the image. Consequently, a response generated by the VLM may lack relevance to the user query, particularly if the user query is directed to elements of the image that are not the focus of the image and/or not prominent.

### SUMMARY

Implementations disclosed herein are directed to at least responding to an input query, comprising a natural language (NL) query and an image, using a vision and language model (VLM). The input NL query and image are processed to generate sub-images (referred to herein as “tiles”) of the input image that are relevant to the NL query. The tiles are processed by one or more image analysis models, such as image search engine(s), to generate image facts that relate to the tiles, e.g., the contents of a tile, identities of objects/people in the tile, or the like. The VLM processes the image tiles, the NL query, and the image facts to generate a response to the input query. The response is rendered at a client device.

In these, and other, manners, a VLM can generate responses that are more relevant to an input image query, for example, if the NL query relates to or refers to entities that are not prominent in the input image.

Additional or alternative implementations disclosed herein are directed to at least using a VLM to link portions of a NL response to corresponding portions of an image from which the response was generated. An input NL query and image are processed to generate sub-images (referred to herein as “tiles”) of the input image that are relevant to the NL query. The VLM processes the image tiles and the NL query to generate a response to the input query. The or a further VLM determines links between portions of the response and corresponding/relevant portions of the input image, e.g., portions of the input image, such as tiles, from which that part of the response was generated. The response is rendered at a client device, with portions of the response being selectable to highlight the corresponding parts of the input image.

In these, and other, manners, a VLM can maintain links between elements of its response and corresponding elements of an input image, allowing a user to identify what parts of the image were used to generate specific portions of the response, which can improve the explainability of the response.

In some implementations, an LLM and/or VLM can include at least hundreds of millions of parameters. In some of those implementations, the LLM/VLM includes at least billions of parameters, such as one hundred billion or more parameters. In some additional or alternative implementations, an LLM/VLM is a sequence-to-sequence model, is Transformer-based, and/or can include an encoder and/or a decoder. One non-limiting example of an LLM is GOOGLE'S Pathways Language Model (PaLM). Another non-limiting example of an LLM is GOOGLE'S Language Model for Dialogue Applications (LaMDA). One non-limiting example of a VLM is GOOGLE'S Gemini-VLM. However, and as noted, it should be noted that the LLMs/VLMs described herein are one example of generative machine learning models and are not intended to be limiting.

The preceding is presented as an overview of only some implementations disclosed herein. These and other implementations are disclosed in additional detail herein.

### BRIEF DESCRIPTION OF THE DRAWINGS

FIG. 1 depicts a block diagram of an example environment that demonstrates various aspects of the present disclosure, and in which some implementations disclosed herein can be implemented.

FIG. 2 depicts an overview of an example method for responding to an input query.

FIG. 3 illustrates an overview of a further example method for responding to an input query.

FIG. 4 depicts a flowchart that illustrates an example method of responding to an input query.

FIG. 5 depicts a flowchart that illustrates a further example method of responding to an input query.

FIG. 6 depicts an example architecture of a computing device, in accordance with various implementations.

### DETAILED DESCRIPTION

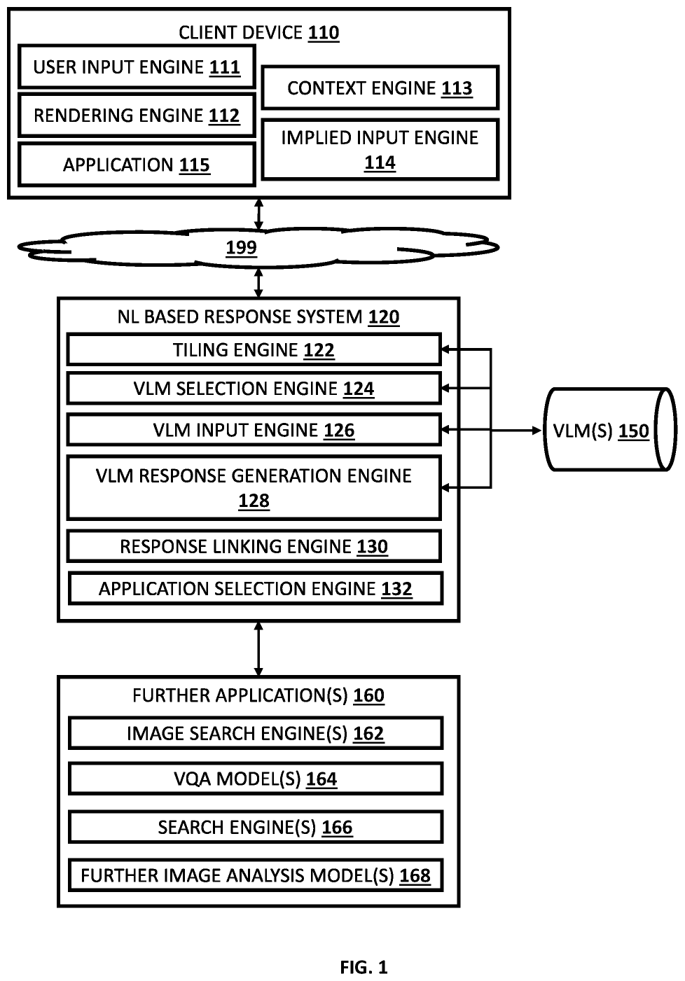

Turning now to FIG. 1, a block diagram of an example environment 100 that demonstrates various aspects of the present disclosure, and in which implementations disclosed herein can be implemented is depicted. The example environment 100 includes a client device 110, a natural language (NL) based response system 120, and one or more further applications 160 (i.e. applications external to a VLM or a dialogue application executed on the client device 110). Although illustrated separately, in some implementations all or aspects of NL based response system 120 and all or aspects of the one or more further applications 160 can be implemented as part of a cohesive system.

In some implementations, all or aspects of the NL based response system 120 can be implemented locally at the client device 110. In additional or alternative implementations, all or some aspects of the NL based response system 120 can be implemented remotely from the client device 110 as depicted in FIG. 1 (e.g., at remote server(s)). In such implementations, the client device 110 and the NL based response system 120 can be communicatively coupled with each other via one or more networks 199, such as one or more wired or wireless local area networks (“LANs,” including Wi-Fi LANs, mesh networks, Bluetooth, near-field communication, etc.) or wide area networks (“WANs”, including the Internet).

The client device 110 can be, for example, one or more of: a desktop computer, a laptop computer, a tablet, a mobile phone, a computing device of a vehicle (e.g., an in-vehicle communications system, an in-vehicle entertainment system, an in-vehicle navigation system), a standalone interactive speaker (optionally having a display), a smart appliance such as a smart television, and/or a wearable apparatus of the user that includes a computing device (e.g., a watch of the user having a computing device, glasses of the user having a computing device, a virtual or augmented reality computing device). Additional and/or alternative client devices may be provided.

The client device 110 can execute one or more applications, such as application 115, via which queries can be submitted and/or NL response(s) to the query can be rendered (e.g., audibly and/or visually). The application 115 can be an application that is separate from an operating system of the client device 110 (e.g., one installed “on top” of the operating system)—or can alternatively be implemented directly by the operating system of the client device 110. For example, the application 115 can be a web browser installed on top of the operating system, or can be an application that is integrated as part of the operating system functionality. The application 115 can interact with the NL based response system 120.

In various implementations, the client device 110 can include a user input engine 111 that is configured to detect user input provided by a user of the client device 110 using one or more user interface input devices. For example, the client device 110 can be equipped with one or more microphones that capture audio data, such as audio data corresponding to spoken utterances of the user or other sounds in an environment of the client device 110. Additionally, or alternatively, the client device 110 can be equipped with one or more vision components that are configured to capture vision data corresponding to images and/or movements (e.g., gestures) detected in a field of view of one or more of the vision components. Additionally, or alternatively, the client device 110 can be equipped with one or more touch sensitive components (e.g., a keyboard and mouse, a stylus, a touch screen, a touch panel, one or more hardware buttons, etc.) that are configured to capture signal(s) corresponding to touch input directed to the client device 110. Some instances of a query described herein can be a query that is formulated based on user input provided by a user of the client device 110 and detected via user input engine 111. For example, the query can be a typed query that is typed via a physical or virtual keyboard, a suggested query that is selected via a touch screen or a mouse, a spoken voice query that is detected via microphone(s) of the client device, or an image query that is based on an image captured by a vision component of the client device or selected from a plurality of images accessible by the device 110.

In various implementations, the client device 110 can include a rendering engine 112 that is configured to provide content (e.g., an NL based response) for audible and/or visual presentation to a user of the client device 110 using one or more user interface output devices. For example, the client device 110 can be equipped with one or more speakers that enable content to be provided for audible presentation to the user via the client device 110. Additionally, or alternatively, the client device 110 can be equipped with a display or projector that enables content to be provided for visual presentation to the user via the client device 110.

In various implementations, the client device 110 can include a context engine 113 that is configured to determine a context (e.g., current or recent context) of the client device 110 and/or of a user of the client device 110. In some of those implementations, the context engine 113 can determine a context utilizing current or recent interaction(s) via the client device 110, a location of the client device 110, profile data of a profile of a user of the client device 110 (e.g., an active user when multiple profiles are associated with the client device 110), and/or other data accessible to the context engine 113. For example, the context engine 113 can determine a current context based on a current state of a query session (e.g., considering one or more recent queries of the query session), profile data, and/or a current location of the client device 110. For example, the context engine 113 can determine a current context based on which application is active in the foreground of the client device 110, a current or recent state of the active application, and/or content currently or recently rendered by the active application. A context determined by the context engine 113 can be utilized, for example, in supplementing or rewriting a query that is formulated based on user input, in generating an implied query (e.g., a query formulated independent of user input), and/or in determining to submit an implied query and/or to render result(s) (e.g., an NL based response) for an implied query.

In various implementations, the client device 110 can include an implied input engine 114 that is configured to: generate an implied query independent of any user input directed to formulating the implied query; to submit an implied query, optionally independent of any user input that requests submission of the implied query; and/or to cause rendering of result(s) for an implied query, optionally independent of any user input that requests rendering of the result(s)). For example, the implied input engine 114 can use current context, from context engine 113, in generating an implied query, determining to submit the implied query, and/or in determining to cause rendering of result(s) for the implied query. For instance, the implied input engine 114 can automatically generate and automatically submit an implied query based on the current context. Further, the implied input engine 114 can automatically push result(s) to the implied query to cause them to be automatically rendered or can automatically push a notification of the result(s), such as a selectable notification that, when selected, causes rendering of the result(s). As another example, the implied input engine 114 can generate an implied query based on profile data (e.g., an implied query related to an interest of a user), submit the query at regular or non-regular intervals, and cause corresponding result(s) for the submission(s) to be automatically provided (or a notification thereof automatically provided). For instance, the implied query can be “patent news” based on profile data indicating interest in patents, the implied query periodically submitted, and a corresponding NL based response result automatically rendered. It is noted that the provided NL based response result can vary over time in view of e.g., presence of new/fresh search result document(s) over time.

Further, the client device 110 and/or the NL based response system 120 can include one or more memories for storage of data and/or software applications, one or more processors for accessing data and executing the software applications, and/or other components that facilitate communication over one or more of the networks 199. In some implementations, one or more of the software applications can be installed locally at the client device 110, whereas in other implementations one or more of the software applications can be hosted remotely (e.g., by one or more servers) and can be accessible by the client device 110 over one or more of the networks 199.

Although aspects of FIG. 1 are illustrated or described with respect to a single client device having a single user, it should be understood that is for the sake of example and is not meant to be limiting. For example, one or more additional client devices of a user and/or of additional user(s) can also implement the techniques described herein. For instance, the client device 110, the one or more additional client devices, and/or any other computing devices of a user can form an ecosystem of devices that can employ techniques described herein. These additional client devices and/or computing devices may be in communication with the client device 110 (e.g., over the network(s) 199). As another example, a given client device can be utilized by multiple users in a shared setting (e.g., a group of users, a household).

NL based response system 120 is illustrated as including a tiling engine 122, a VLM selection engine 124, a VLM input engine 126, a VLM response generation engine 128, a response linking engine 130, and an application selection engine 132. Some of the engines can be omitted in various implementations.

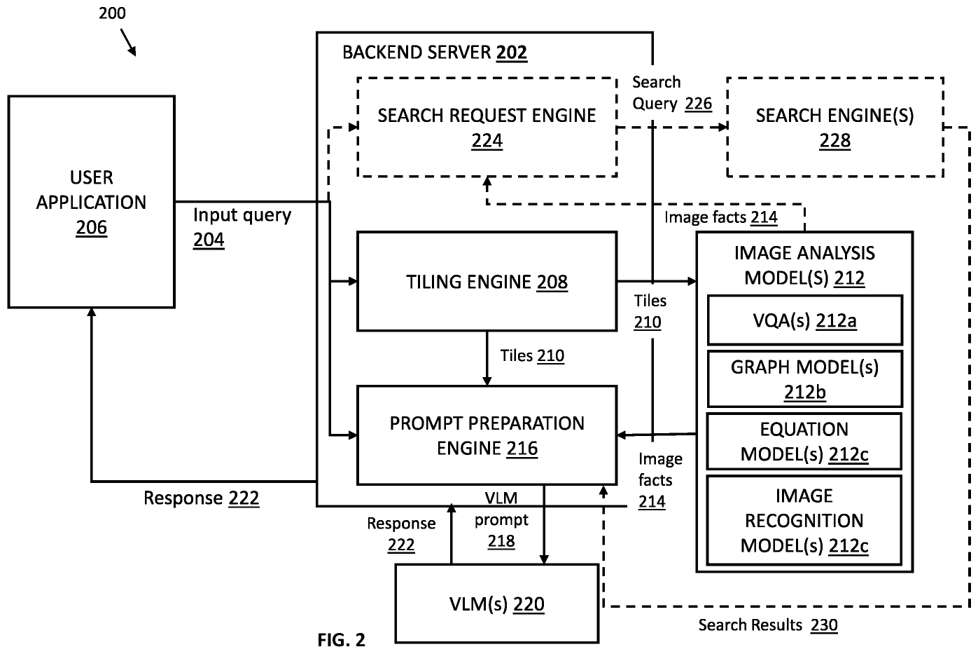

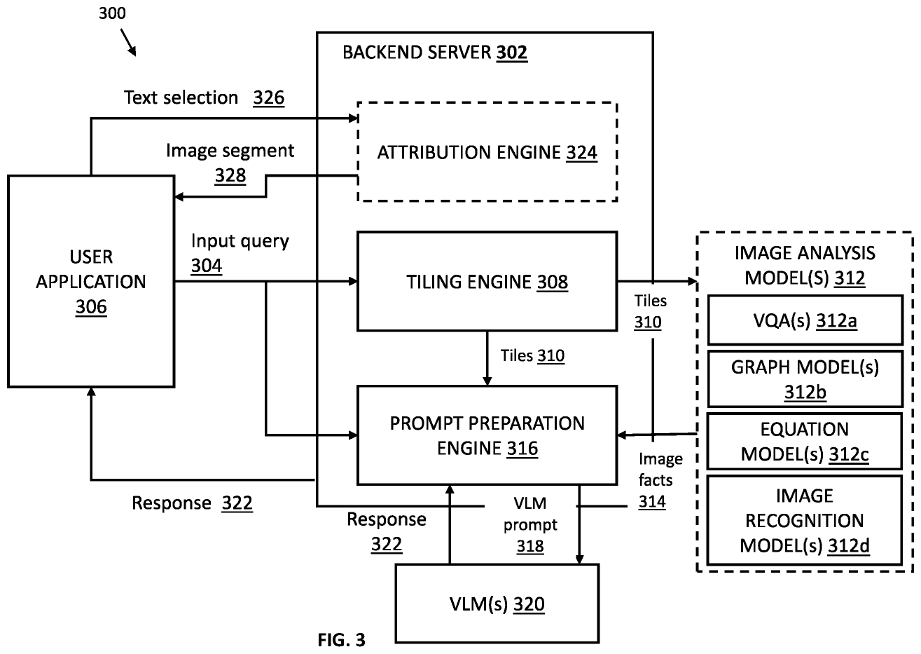

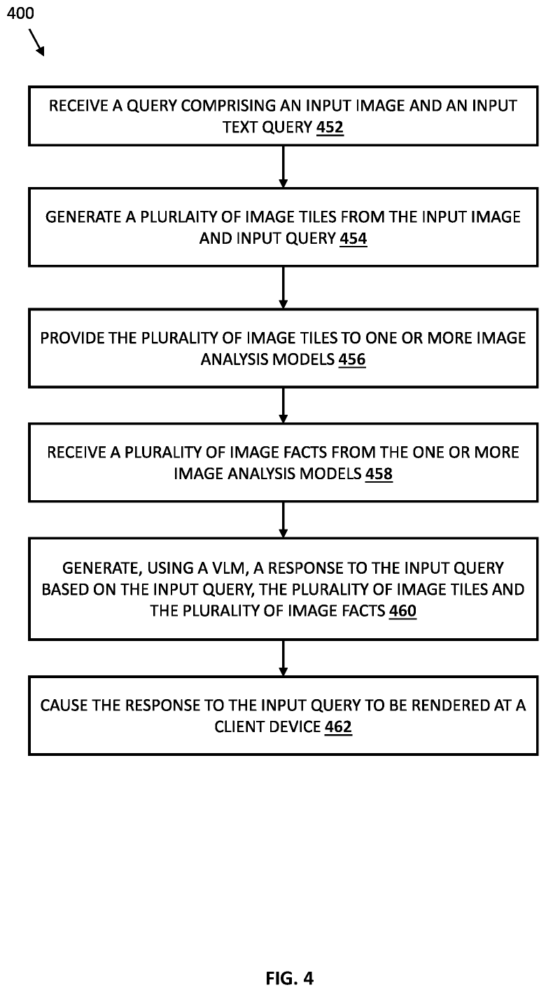

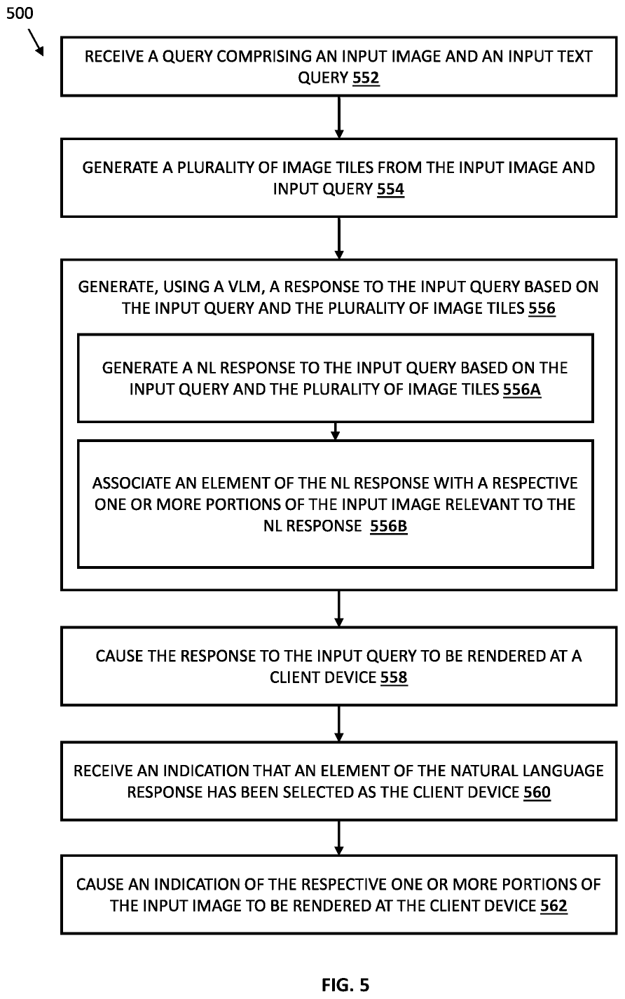

The tiling engine 122 can, in response to receiving a query comprising an image and a text query, generate a plurality of image tiles from the image based on the text query. Each image tile comprises a proper subset of the input image that is relevant to the text query. In some implementations, the tiling engine 122 can utilize one or more VLMs 150 to generate the plurality of tiles. For example, one or more VLMs 150 can be trained/fine-tuned to generate relevant image tiles from an input image and a text query. In some implementations, the tiling engine 122 can utilize one or more object detection models to generate relevant image tiles from an input image and a text query. In various implementations, the tiling engine 122 can perform all or aspects of the tiling engine 208, 308 of FIG. 2 and FIG. 3, aspects of blocks 454 of method 400 of FIG. 4, and/or aspects of block 554 of FIG. 5, etc.

The VLM selection engine 124 can, in response to receiving a query, determine which, if any, of multiple generative model(s) (VLM(s) and/or other generative model(s)) to utilize in generating response(s) to render responsive to the query. For example, the VLM selection engine 124 can select none, one, or multiple generative model(s) to utilize in generating response(s) to render responsive to a query. The VLM selection engine 124 can optionally utilize one or more classifiers and/or rules (not illustrated).

The VLM input engine 126 can, in response to receiving a query, generate VLM input that is to be processed using a VLM in generating an NL based response to the query. As described herein, such content can include query content that is based on the query (e.g., the input NL query and/or the input image) and image tiles, and/or additional content, such as information derived from the one or more further applications 160. In some implementations, the VLM may utilize a downscaled version of the input image. In various implementations, the VLM input engine 126 can perform all or aspects of the prompt preparation engine 216, 316 of FIG. 2 and FIG. 3, aspects of blocks 460 of method 400 of FIG. 4, and/or aspects of block 556 of FIG. 5, etc.

The VLM response generation engine 128 can process VLM input, that is generated by the VLM input engine 126, using a VLM to generate a NL based response. In various implementations, the VLM response generation engine 128 can perform all or aspects of the VLM(s) 220, 320 of FIG. 2 and FIG. 3, block 460 of method 400 of FIG. 4, and/or block 556 of method 500 of FIG. 5. The VLM response generation engine 128 can utilize one or more VLMs 150.

The response linking engine 130 can link elements of the NL response generated by the VLM response generation engine 128 to corresponding elements of the input image. In various implementations, the response linking engine 130 can perform all or aspects of the response rendering engine 324 of FIG. 3, and/or blocks 556-562 of FIG. 5. The response linking engine 130 can utilize one or more VLMs 150.

The application selection engine 132 can select one or more applications from a set of further applications 160 for providing additional information relevant to an input query. The application selection engine 132 can in some examples, select one or more applications 160 based on properties of the plurality of tiles generated by the tiling engine 122. In some implementations, the application selection engine 132 can optionally utilize one or more classifiers and/or rules (not illustrated).

The set of external applications 160 is illustrated as including one or more image search engines 162, one or more visual query answering (VQA) models 164, one or more search engines 166 and one or more further image analysis 168. Some of the engines can be omitted in various implementations.

The one or more image search engines 162 can process image input, e.g. image tiles, to perform a search for image facts relating to the image input. In various implementations, the one or more image search engines 162 can perform all or aspects of the image analysis models 212, 312 of FIG. 2 and/or FIG. 3, and/or blocks 456 and 458 of FIG. 4.

The one or more VQA models 164 can process image input (e.g., one or more image tiles) and an input text query to determine/generate one or more image facts relating to the input text query. In various implementations, the one or more VQA models 164 can perform all or aspects of the VQA(s) 212a, 312a of FIG. 2 and/or FIG. 3, and/or blocks 456 and 458 of FIG. 4.

The one or more search engines 166 can perform searches, e.g. text image searches, based on image facts generated from an input image and/or an input query. The one or more search engines 166 return one or more web resources (e.g. webpages, extracts/snippets of webpages, etc.) that contain at least one of resources responsive to the search. In various implementations, the one or more search engines 166 can perform all or aspects of the search engines 228 of FIG. 2.

The one or more further image analysis models 168 can determine/generate one or more image facts from image input, e.g., from one or more image tiles. One or more of the further image analysis models 168 can, in some implementations, also utilize text input, e.g., a text query. In some implementations, one or more of the further image analysis models 168 are specialized for processing images of respective types, e.g., images containing graph data, images containing mathematical formulae, or the like. In various implementations, the one or more further image analysis models 168 can perform all or aspects of the image analysis models 212, 312 of FIG. 2 and/or FIG. 3, and/or blocks 456 and 458 of FIG. 4.

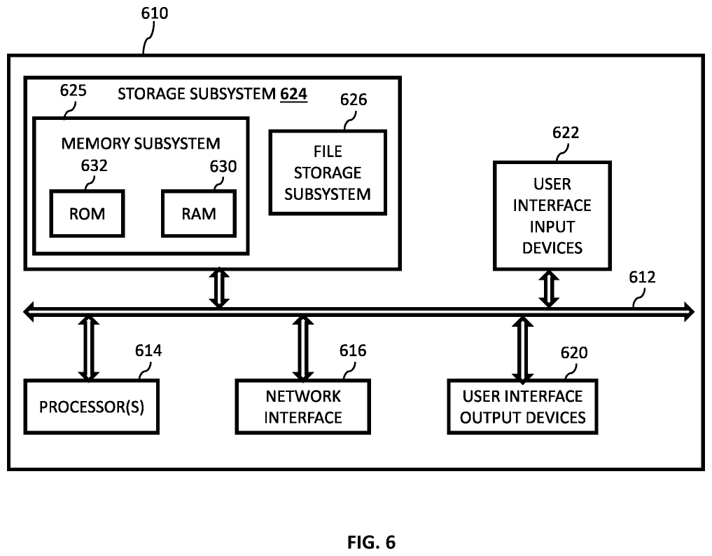

Turning now to FIG. 2, FIG. 2 illustrates an overview of an example method for responding to multimodal query. The method may be performed by one or more computer systems, such as the system described herein in relation to FIG. 6.

A computer system, such as a backend server 202 (e.g., the NL based response system 120 described herein in relation to FIG. 1), receives an input query 204 comprising an input image and an input natural language query from a user application 206 running on a client device (such as client device 110 described herein in relation to FIG. 1). The input natural language query may refer to the input image (either explicitly or implicitly). The input query 204 is processed by a tiling engine 208, which generates a plurality of image tiles 210 from the input image based at least in part on the input natural language query. The image tiles 210 are utilized by one or more image analysis models 212 to determine one or more respective image facts 214 relating to the image tiles 210. A prompt preparation engine 216 generates one or more prompts 218 for one or more VLMs 220 based at least in part on the plurality of image tiles 210, the input natural language query and the one or more image facts 214. The one or more VLMs 220 process the generated prompts 218 to generate one or more responses 222 to the input query 204. One or more of the responses 222 are output to a user via the user application 206 on the client device.

In some implementations, a search request engine 224 generates one or more natural language search requests 226 from the input natural language query and the one or more image facts 214. The one or more search requests 226 are transmitted to one or more search engines 228, which perform searches (e.g., a web search and/or a database search) based on the search requests 226, and generate one or more search responses 230. The search responses 230 are provided to the prompt preparation engine 216, which utilizes the search responses 230 when generating the one or more prompts 218 for one or more VLMs 220, i.e., the one or more prompts 218 for one or more VLMs 220 are further based on the one or more search responses 230.

The input natural language query is, in some examples, received in the form of an input text query. The input text query can, for example, originate as text input manually by a user of the user application 206. Alternatively or additionally, the input text query can originate from a spoken input to the user application 206, e.g. a spoken query input after invoking the user application 206. The spoken input is converted to the input text query by a speech-to-text engine running on the client device (either as part of the user application 206, or accessible by the user application 206).

The input text query may refer to the input image, either explicitly or implicitly. The input text query may also refer to one or more objects in the input image, either explicitly or implicitly. For example, an explicit text query is “what are the contents of the toolbox in this image?”. This query refers to both the input image (“this image”) and an object (“the toolbox”) in the image explicitly. An example of an implicit text query is “what is in it?”. This query refers to the image and an object in the image (“it”) implicitly, e.g. by virtue of being submitted with the input image. In some examples, an input text query contains both implicit and explicit references to the image and/or one or more objects in the image.

The input text query is, in some examples, part of an ongoing human-computer dialogue, e.g. a sequence of input queries (with or without corresponding input images) and their corresponding responses from the NL based response system. For example, a first input query comprises an image of a toolbox and a text query “What is in the image?”. The NL based response system generates a response (e.g. using any of the methods described herein) and responds with “A toolbox”. A further text query, “What is in it?”, is received from the user.

The tiling engine 208 acts to generate a plurality of relevant image tiles 210 from an input image based on a corresponding input natural language query. The tiling engine 208 is, in some examples, a VLM, or has access to one or more VLMs 220. In some examples, the VLM is a specialized tiling VLM, i.e., trained/fine-tuned to generate image tiles from image input and text input. Alternatively, the VLM is a more general VLM, and may, in some examples be one or more of the VLMs 220. Other types of image processing model may alternatively be used, e.g., one or more object detection and classification models that have been trained to detect and/or identify objects in an image, and/or locate objects in an image.

The input image is, in some implementations, scaled down (i.e., downsampled to a lower resolution) prior to generating the tiles 210 to improve efficiency.

In some implementations, the tiling engine 208 generates one or more bounding boxes, each corresponding to a portion of the input image that is relevant to the natural language query. For example, the tiling engine generates the coordinates of two or more vertices to define each bounding box. In some examples, a bounding box defining a tile is aligned with the input image, i.e., the edges of the bounding box are aligned/parallel with the edges of the image. In some examples, a bounding box defining a tile can be rotated with respect to the input image, the edges of the bounding box are not aligned/parallel with the edges of the image.

In some implementations, the tiling engine 208 is further provided with a representation of a dialogue history. For example, previous text queries, input as part of a current dialogue session and prior to a current text query, and their respective responses are input into the tiling engine 208 as context.

In examples where the tiling engine 208 comprises one or more VLMs, the input to a VLM may be a prompt requesting that the VLM generate image tiles relevant to an input natural language query. For example, the input prompt may be “Here is an image. Please generate image tiles relevant to the following query from the image”, followed by the natural language query and/or a conversation history.

Continuing with the example of the image of a toolbox, a VLM takes the image as input along with the prompt “Here is an image. Please generate image tiles relevant to the following query from the image. Query: What is in the toolbox in this image?”. The VLM processes the input prompt and image and generates a plurality of image tiles, e.g., a bounding box of the toolbox and, in some examples, bounding boxes of objects in the toolbox. The bounding boxes define tiles of the image.

In some implementations, the tiling engine 208 generates image tiles 210 iteratively. In such examples, the tiling engine 208 generates one or more image tiles 210 from an input image, using any of the methods described herein. The tiling engine 208 then generates one or more further image tiles (i.e., sub-tiles) from the image tiles 210 and the input natural language query. The further tiles may themselves be re-input into the tiling engine 208. For example, when the tiling engine 208 utilizes a VLM, the image tiles 208 may be input into the VLM with the prompt: “Here is an image. Please generate image tiles relevant to the following query from the image”, or “Here is an image tile. Please generate image sub-tiles relevant to the following query from the image.” The VLM processes the input tiles and generates further relevant tiles from the input tiles.

Returning to the example of the image of a toolbox, a VLM takes the image containing a toolbox as input along with the prompt “Here is an image. Please generate image tiles relevant to the following query from the image. Query: What is in the toolbox in this image?”. The VLM processes the input prompt and image and one or more image tiles, e.g., a bounding box of the toolbox. The image tile defined by the bounding box, i.e., the tile containing the toolbox, is input into the VLM along with the prompt “Here is an image tile. Please generate image sub-tiles relevant to the following query from the image. Query: What is in the toolbox in this image?”. The VLM processes the tile of the toolbox and the prompt to generate one or more further tiles, e.g., bounding boxes of objects in the toolbox.

Such recursive tile generation is, in some implementations, triggered based on one or more trigger conditions being satisfied. For example, the one or more image analysis model 212 that process the tiles to determine image facts may not generate image facts of a sufficient quality, e.g., a confidence value in one or more image facts may be below a threshold value. In response, the system 200 causes the tiling engine 208 to generate further tiles. Other examples of trigger conditions include, for example, one or more of the image tiles being above a threshold size.

In some implementations, the tiling engine can receive one or more user input tiles and include them in the plurality of tiles 210. A user can select one or more elements of the input image to be used as tiles 210 through the user application 206, for example, by highlighting portions of the input image and/or dragging a selection box over portions of the input image.

The image tiles 210 are sent to one or more image analysis models 212. An image analysis model processes an input tile 210 and determines one or more image facts 214 about the input tile 210. In some examples, the input natural language query is also provided to one or more of the image analysis models 212. In some implementations, the image tiles 210 are sent to one or more of the image analysis models 212 in parallel, e.g., an image analysis model 212 receives a plurality of image tiles in parallel, and can generate/determine image facts relating to the image tile in parallel.

The image analysis models 212 may, in some examples, comprise one or more of: one or more image search engines; one or more visual query answering models 212a; one or more graph analysis models 212b (such as, for example, GOOGLE's DePlot); one or more equation analysis models 212c (such as GOOGLE's Photomath); one or more image recognition models 212d (such as, for example, GOOGLE Lens); one or more object classification models; one or more table analysis models; one or more text recognition models; or the like. Other examples will be familiar to those skilled in the art.

In some implementations, the system 200 routes tiles 210 to respective image analysis models based on the contents of the tile. The system 200 may determine a tile classification, and determine one or more of the image analysis models 212 to send the tile to for analysis. In some examples, the tiling engine 208 determines a tile classification when generating the image tiles 210, for example using the VLM used to generate the tiles 210. The VLM used by the tiling model may be fine-tuned to suggest which image analysis model(s) to use for generating the image facts. Alternatively, a pretrained image classification model can be used to classify an image tile into one of a plurality of classes. Each class is associated with one or more image analysis models 212. For example, a “product” class is associate with one or more image search engines and/or one or more image recognition models, an “equation” class is associated with one or more equation analysis models, a “text” class is associated with one or more text recognition models (e.g., an OCR model), and/or a “chart” and/or “graph” class is associate with one or more graph analysis models. Alternatively, the classes themselves may be the identity of one or more image analysis models 212.

As an example, an input query 204 comprises an image of a teacher teaching a mathematics class and a natural language query “what topic is the teacher teaching?”. Based on the natural language query, the tiling engine 208 generates a first tile 210 of a blackboard covered in equations in the image and a second tile of a textbook cover in the image. The tiling engine 208 classifies the first tile into the class “equation” and the second tile into the classes “text” and “product”. The first tile is sent to an equation analysis model, which returns the image fact “group axioms”. The second image tile is sent to a text recognition model and an image search engine. The text recognition model returns the image fact “Elementary Group Theory” based on recognizing the text of the title of the textbook. The image search engine returns the image fact “Undergraduate mathematics textbook” based on an image search of the tile.

The prompt engine 216 generates a VLM prompt 218 based on the input natural language query, the image tiles 210 and the image facts 214. The VLM prompt 218 is input into one or more VLMs 220, which process the prompt to generate a response 222.

In some examples, the prompt generation engine 216 transforms the input natural language query, the image tiles 210 and the image facts 214 into a VLM prompt 218 using a static schema. For example, the prompt generation engine 216 generates a VLM prompt 218 by performing operations that comprise filling one or more slots in respective predefined prompt templates with a tile 210 and the respective image facts associated with the tile. In some examples, an identifier of the model/model type that generated the image fact may also be included in the prompt. The full VLM prompt 218 further comprises the input natural language query. In some implementations, the full VLM prompt 218 is enriched with the conversation history, e.g. a full history of the inputs and response of a current dialogue, or a natural language summary of the current dialogue. In some implementations, the full VLM prompt 218 further includes one or more instructions to the VLM, e.g., “Please reply in a polite and helpful manner.”

Taking the example of the classroom, an example VLM prompt 218 generated by the prompt generation engine 216 is:
“Please reply in a polite and helpful manner.
Query: what topic is the teacher teaching?;
[Image tile 1—blackboard];
Image fact: [Equation] Group axioms;
[Image tile 2];
Image fact: [Text] Elementary Group Theory;
Image fact: [Image search] Undergraduate mathematics textbook.

The VLM(s) generates a corresponding response 222 by processing the input prompt. In the example, the VLM(s) 220 generates the response “The teacher is teaching undergraduate group theory using the textbook “Elementary Group Theory”.”

The response is then rendered at the user application 206, e.g. as text in a text-based dialogue/chat application, converted to speech using a text-to-speech engine, or the like.

In some implementations, the backend server 202 further comprises a search request engine 224. The search request engine receives the input natural language query and image facts 214 and generates one or more search requests 226 for one or more search engines 228. The backend server 202 transmits the one or more search requests 226 to the one or more search engines 228, which perform a web search using the search requests 226. The results 230 of the web searches are provided to the prompt engine 216 which uses the search results 230 when generating the prompt 218 for the VLM(s) 220.

For example, documents and/or text snippets returned by the search engine 228 may be included in the prompt 218 generated by the prompt engine 216, e.g., by being appended to the prompt and/or by being included with the text relating to the image facts from which the corresponding search query 226 was generated.

In some implementations, the prompt engine 216 may generate the VLM prompt 218 from the input natural language query, the image tiles 210 and the search results 230, without using the image facts 214 directly. For example, the search engine results 230 may be used in place of the image facts 214 when generating the VLM prompt 218.

Turning now to FIG. 3, FIG. 3 illustrates an overview of an example method for responding to an image query. The method may be performed by one or more computer systems, such as the system described herein in relation to FIG. 6. The method may be combined with the method of FIG. 2. Alternatively, the method may be performed individually.

A computer system, such as a backend server 302 (such as the NL based response system 120 described herein in relation to FIG. 1), receives an input query 304 comprising an input image and an input natural language query that relates to the input image from a user application 306 running on a client device (such as client device 110 described herein in relation to FIG. 1). Based on the input image and input natural language query, the backend server 302 generates one or more image tiles 310 using a tiling engine 308, for example as described in relation to tiling engine 208 and tiles 210 of FIG. 2. A prompt preparation engine 316 uses the one or more image tiles 310 and the input natural language query to generate a VLM prompt 318 for one or more VLMs 320, for example as described in relation to prompt preparation engine 216 of FIG. 2. In some examples, the backend server 302 also utilizes one or more image analysis models 312 to generate one or more image facts 314 that each correspond to a respective one or more image tiles 310, for example as described in relation to image analysis models 212 of FIG. 2. Based on the prompt 318, the one or more VLMs 320 generate a response 322 to the input query 304.

One or more of the VLMs 320 have been trained/fine-tuned to maintain relationships between segments of the response 322 and tiles 310 of the image (or other image portions of the image), i.e., the VLM(s) 320 associate one or more elements of the response 322 with respective tiles 310, or other image portions, in the image from which that element of the response 322 was generated by the VLM. For example, the VLM response 322 may include a tile identifier with one or more elements of the response.

For example, the input query may contain a picture of a street containing a number of cars, and a natural language query “what make is the red car?” The tiling engine 308 generates a plurality of image tiles 310 based on the natural language query, where a plurality of the image tiles contain a respective car in the image. The prompt preparation engine 316 prepares a VLM prompt 318 based on the image and the natural language query, and, in some implementations, image facts 314 generated from the image tiles. For example, the preparation engine 316 prepares the prompt:
“Please reply in a polite and helpful manner.
Query: what make is the red car?;
[Image tile 1—red car];
Image fact: [Object] Red BMW car;
[Image tile 2—green car];
Image fact: [Object] Green VW car;
[Image tile 3—white car];
Image fact: [Object] White Tesla.

Based on this prompt, the VLM generates, for example, the response “The green car is a Volkswagen. The image also contains a red BMW and a white Tesla”, and stores data indicative of links between the response portion “The green car is a Volkswagen” and tile 2, “a red BMW” and tile 1, and “a white Tesla” and tile 3.

In some implementations, the or a further VLM can be trained/fine-tuned for flexible attribution. A VLM model can be trained with a fine-tuning dataset where each example has an image and text (a segment of a model response to the image) and the target is a tile of the image corresponding to the text. At inference time, this allows the VLM to attribute a text segment in the response to any part of the image, and is not restricted to attributing the text segment to the tiles 310 used to generate the response 322.

The response 322 is rendered at the user application 306, e.g., as text in a text-based dialogue/chat application. The rendered response, in some examples, also comprises the input image. Alternatively, the user application may maintain a rendering of the input image from the query submission, e.g., as part of an ongoing dialogue.

In some implementations, the user application 306 receives the data indicative of links between response portions and image portions, and stores the data locally on the client device running the user application 306. Alternatively or additionally, the data indicative of links between response portions and image portions can be stored at the backend server 302, for example in an attribution engine 324.

Subsequent to rendering the response at the user application 306, the user application receives user input selecting a portion 326 of the NL part of the response, e.g., a selection of a part of the text of the response 322. Based on the selected text 326, a corresponding part of the input image 328 is highlighted in the response, e.g., a bounding box or some other highlighting is applied to the part of the input image that corresponds to the selected text 326 of the response 322. Alternatively or additionally, the part of the input image that corresponds to the selected text 326 of the response 322 may be rendered at the client device 306, e.g., one or more tiles corresponding to the selected text are rendered as part of an ongoing dialogue process at the client device 306.

Returning to the example of the cars, the client device 306 renders the response 322 “The green car is a Volkswagen. The image also contains a red BMW and a white Tesla.” A user selects the text “a white Tesla,” for example by highlighting the text in the response. The selection causes the bounding box of tile 3 to be rendered on the input image, e.g., as an overlay. The user then, for example, proceeds to select the text “The green car.” This causes the client device 306 to render the bounding box of tile 2 on the input image, e.g., as an overlay, and cease rendering box 3.

The links can, in some implementations, also allow a user to select portions of the input image and have corresponding textual segments of the response 322 highlighted. For example, tiles selected in the image could be clickable/touchable and interaction with them could, for example, display more details. The interaction with these tiles could highlight (or move the user to) the relevant part of the response 322.

In some implementations, the VLM generating the response does not determine links between the response and the input image while generating the response. Instead, an attribution engine 324, located at either the backend server 302 or the user device, can receive the text selection 326 from the user application 306 and determine a relevant part of the input image. A VLM 320 can be used to determine this link, for example, a VLM trained on a training dataset where each training example has an image and text (a segment of a model response to the image) and the target is a tile of the image corresponding to the text, for example collected using human annotation. Such a VLM takes input comprising the selected text segment 326 and the input image, and outputs data identifying one or more regions of the input image that are relevant to the text segment, e.g., data identifying a bounding box in the input image.

For example, in the case of the image containing cars, a user selects the text “a white Tesla,” for example by highlighting the text in the response. The selected text is input into a VLM along with the input image, for example using the prompt “Which part of the image is related to this text extract: a white Tesla” along with the image. The VLM outputs data indicating the location of a bounding box that contains the white Tesla, and provides the data to the client application 306. The client application then renders the bounding box on the input image, e.g., as an overlay.

In some implementations, the method of FIG. 3 is combined with the method of FIG. 2, i.e. the method of FIG. 3 may additionally utilize the image analysis models 212 and search engines 228 of FIG. 2.

Turning now to FIG. 4, a flowchart is depicted that illustrates an example method 400 of responding to a multimodal query. The method 400 corresponds to the method 200 described in relation to FIG. 2. For convenience, the operations of method 400 are described with reference to a system that performs the operations. This system of method 400 includes one or more processors, memory, and/or other component(s) of computing device(s) (e.g., the NL-based response system 120 of FIG. 1). Moreover, while operations of the method 400 are shown in a particular order, this is not meant to be limiting. One or more operations may be reordered, omitted, and/or added.

At block 452, the system receives a query. The query comprises an input image and an input text query. The query can be one formulated based on user interface input at a client device, such as typed input, voice input, input to cause an image to be captured or selected, etc. The text query can be, for example, a voice query, a typed query, or an inferred/parameterless query. In some implementations, when the query includes content that is not in textual format, the system can convert the query to a textual format or other format. For example, if the query is a voice query the system can perform automatic speech recognition (ASR) to convert the voice query into textual format.

The query can alternatively be an implied query, such as one formulated and/or submitted independent of any user input directed to formulating the implied query. For example, the query can be an implied query that is automatically generated based on profile data and that is automatically submitted. For instance, the implied query can be “machine learning”, based on profile data indicating interest in machine learning topic(s). As another example, the query can be an implied query that is automatically generated and/or automatically submitted based on a current and/or recent context. As yet another example, the query can be an implied query that is submitted based on the user providing some indication of a desire to perform a search (e.g., pushing a search button, performing a search touch gesture, accessing a particular screen or state of an application), but that is generated automatically based on content currently being displayed at a client device, location, time of day, and/or other context signal(s).

At block 454, the system generates a plurality of image tiles from the input image and the input query. The tile may, in some examples, be generated from a scaled-down (e.g., downsampled) version of the input image.

In some implementations, a VLM is used to generate the plurality of image tiles. The VLM, for example, comprises the same VLM that is used to generate a response to the query in block 460. Alternatively, the VLM is an auxiliary LLM, i.e. a specialized VLM that has been trained/fine-tuned to generate image tiles from an image and a query. The training/fine-tuning may be based on a labeled dataset comprising training examples that each comprise an image, a natural language query and a set of corresponding image tiles relevant to the query. The dataset may have been generated using human annotations.

In such implementations, the method may comprise inputting the input image and the input natural language query into a VLM and processing the input image and the input query using the VLM to generate the plurality of image tiles. An instruction to generate image tiles may also be input into the VLM. Once generated, the VLM outputs a plurality of image tiles.

The plurality of image tiles may be generated recursively by inputting generated image tiles back into the VLM along with the input query. The VLM processes the input tiles and the input natural language query to generate further image tiles, i.e., sub-tiles of the image.

In some implementations, an object detection model is used to generate the plurality of image tiles. The object detection model is a non-VLM based model that takes as input the image and, in some examples, the input natural language query, and outputs identities and locations of objects in the image.

In some examples, an image tile is defined by a bounding box, e.g., the location of two or more vertices of the tile bounding box in the input image. In some examples, the image tile is aligned with the image. In such examples a bounding box can be defined by two vertex locations. In some examples, the image tile may be rotated with respect to the image. In such examples a bounding box can be defined by three or four vertex locations, or two vertex locations and a rotation angle.

In some implementations, the system determines a classification of one or more (e.g., each) image tiles in the plurality of image tiles. For example, the VLM can output a classification of an image tile that indicates which one or more of a plurality of classes the image tile belongs to. The classes may identify, or correspond to, respective image analysis models used in block 456.

At block 456, the system provides the plurality of image tiles to one or more image analysis models. The image tiles may be provided to the one or more image analysis models in parallel. The one or more image analysis models process their received image tiles to determine one or more image facts about the image tiles, i.e., one or more properties of the contents image tile. The one or more image analysis models may comprise one or more of: one or more image search engines; one or more image recognition models; one or more visual query answering models; one or more graph analysis models; one or more equation analysis models; one or more object classification models; one or more table analysis models; one or more text recognition models; or the like.

In some implementations, a tile is provided to a respective one or more image analysis models based on a classification of the tile, e/g/. the classification output by the VLM at operation 454.

At block 458, the system receives a plurality of image facts from the one or more image models. Examples of such image facts include, but are not limited to: objects/person identities of objects/people in a tile; text extracted from a tile; data extracted from graphs/charts in a tile; equations and/or identities of equations in a tile; classifications of a tile; natural language descriptions of a tile; and/or the like.

In some implementations, the method further comprises generating one or more search requests based on the input query and one or more of the image facts. In some examples, the search query is further based on one or more image tiles that correspond to the one or more image facts. The search query is sent to one or more search engines. The one or more search engines perform searches based on the one or more search queries, and return one or more search responses. The search responses may comprise one or more text samples, e.g., webpages and/or extracts from web pages.

At block 460, the system generates a response to the input query based on the input query, the plurality of image tiles, and the plurality of image facts using the VLM. The VLM processes a prompt based on the input query (e.g. the input natural language query and in some example, the input image), the plurality of image tiles and the plurality of image facts to generate a natural language (e.g., text) response, and outputs the response. In implementations where the system utilizes a search engine, the prompt is further based on one or more search responses.

The system may generate a VLM prompt based on the input query, the plurality of image tiles, and the plurality of image facts, for example using a static schema. The VLM prompt is input into the VLM, which processes the prompt to generate a response. The prompt may comprise a sequence of image tiles and image facts (and, in some implementations, corresponding search results) that are input into the VLM sequentially, e.g., the VLM processes each tile and associated image facts and searches in sequence. Alternatively, the image tiles and image facts (and, in some implementations, corresponding search results) are input into the VLM in parallel, e.g., the whole prompt is processed at once.

At block 462, the system causes the response to the input prompt to be rendered at the client device. For example, the system can cause the response to be rendered graphically in an interface of an application of a client device via which the query was submitted. As another example, the system can additionally or alternatively cause the response to be audibly rendered via speaker(s) of a client device via which the query was submitted. The response can be transmitted from the system to the client device, if the system is remote from the client device.

Turning now to FIG. 5, a flowchart is depicted that illustrates an example method 500 of responding to an image-based query. The method 500 corresponds to the method 300 described in relation to FIG. 3. For convenience, the operations of the method 500 are described with reference to a system that performs the operations. This system performing the method 500 includes one or more processors, memory, and/or other component(s) of computing device(s) (e.g., the NL-based response system 120 of FIG. 1). Moreover, while operations of the method 500 are shown in a particular order, this is not meant to be limiting. One or more operations may be reordered, omitted, and/or added. One or more of the operations may be performed alongside or in addition to operations of FIG. 4, e.g. in parallel or in sequence.

At block 552, the system receives a query. The query comprises an input image and an input text query that relates to the input image (either implicitly or explicitly). Block 552 may, for example, correspond to block 452 of FIG. 4.

At block 554, the system generates a plurality of image tiles from the input image and the input query. Block 554 may, for example, correspond to block 454 of FIG. 4.

At block 556, the system generates, using a VLM, a response to the input query based on the input query and the plurality of image tiles. Generating a response to the input query based on the input query and the plurality of image tiles comprises, at block 556A, generating a NL response to the input query based on the input query and the plurality of image tiles, and at block 556B associating an element of the NL response (e.g., a word, a phrase, a sentence, a text extract, etc.) with a respective one or more portions of the input image relevant to that element of the NL response (e.g., one or more of the image tiles, one or more segments of the image, a plurality of image pixels, etc.).

As an example, the VLM may output one or more tile identifiers for each of one or more portions of the NL response, where the tile identifiers identify a tile from which that part of the NL response was generated. In some implementations, each portion of the response is associated with a respective one or more image tiles. In some implementations, one or more portions of the NL response may remain unassociated with a respective image tile.

In some implementations, the VLM or a further VLM has been trained/fine-tuned to generate the associations between the input tiles and the NL response. For example, the VLM may be trained/fine-tuned using a human annotated dataset comprising a set of NL responses, and corresponding image tiles that are associated with portions of the NL responses.

Alternatively, the VLM or a further VLM may output one or more locations in the input image for a respective one or more portions of the natural language response, e.g., coordinate ranges, bounding boxes, or the like. The VLM or further VLM may be trained/fine-tuned on a dataset comprising a plurality of training examples. A training example comprises a NL response and a corresponding input image, with one or more portions of the NL response labelled as being associated with respective portions of the input image.

In some examples, block 556 may further include the operations of blocks 456 to 460 of FIG. 4. In other examples, block 556 does not include the operations of blocks 456 to 460 of FIG. 4.

At block 558, the system causes the response to the input prompt to be rendered at the client device. For example, the system can cause the response to be rendered graphically in an interface of an application of a client device via which the query was submitted. As another example, the system can additionally or alternatively cause the response to be audibly rendered via speaker(s) of a client device via which the query was submitted. The response can be transmitted from the system to the client device, if the system is remote from the client device.

At block 560, the system receives an indication that an element of the natural language response has been selected at the client device. A user can select a portion of the NL response that is rendered at the user device, for example by highlighting a portion of the text of the NL response, or clicking on a portion of the text.

At block 562, the system causes an indication of the respective one or more portions of the input image that correspond to the selected portion of the NL response to be rendered at the client device. The indication comprises, in some examples, rendering bounding boxes of the one or more portions of the input image as an overlay on the input image. For example, where the one or more portions of the input image are one or more image tiles generated at block 554, the system causes the bounding boxes of the one or more image tiles to be rendered at the client device.

Alternatively or additionally, the system receives a user selection of a portion of the input image. For example, a user may define a bounding box around one or more features of the input image, e.g., by dragging a box around a part of the input image. In response, the system causes an indication of one or more corresponding elements of the NL response to be rendered at the client device, e.g., by highlighting, underlining and/or boldfacing the one or more corresponding elements of the NL response.

Turning now to FIG. 6, a block diagram of an example computing device 610 that may optionally be utilized to perform one or more aspects of techniques described herein is depicted. In some implementations, one or more of a client device, cloud-based automated assistant component(s), and/or other component(s) may comprise one or more components of the example computing device 610.

Computing device 610 typically includes at least one processor 614 which communicates with a number of peripheral devices via bus subsystem 612. These peripheral devices may include a storage subsystem 624, including, for example, a memory subsystem 625 and a file storage subsystem 626, user interface output devices 620, user interface input devices 622, and a network interface subsystem 616. The input and output devices allow user interaction with computing device 610. Network interface subsystem 616 provides an interface to outside networks and is coupled to corresponding interface devices in other computing devices.

User interface input devices 622 may include a keyboard, pointing devices such as a mouse, trackball, touchpad, or graphics tablet, a scanner, a touch screen incorporated into the display, audio input devices such as voice recognition systems, microphones, and/or other types of input devices. In general, use of the term “input device” is intended to include all possible types of devices and ways to input information into computing device 610 or onto a communication network.

User interface output devices 620 may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide non-visual display such as via audio output devices. In general, use of the term “output device” is intended to include all possible types of devices and ways to output information from computing device 610 to the user or to another machine or computing device.

Storage subsystem 624 stores programming and data constructs that provide the functionality of some or all of the modules described herein. For example, the storage subsystem 624 may include the logic to perform selected aspects of the methods disclosed herein, as well as to implement various components depicted in FIG. 1.

These software modules are generally executed by processor 614 alone or in combination with other processors. Memory 625 used in the storage subsystem 624 can include a number of memories including a main random access memory (RAM) 630 for storage of instructions and data during program execution and a read only memory (ROM) 632 in which fixed instructions are stored. A file storage subsystem 626 can provide persistent storage for program and data files, and may include a hard disk drive, a floppy disk drive along with associated removable media, a CD-ROM drive, an optical drive, or removable media cartridges. The modules implementing the functionality of certain implementations may be stored by file storage subsystem 626 in the storage subsystem 624, or in other machines accessible by the processor(s) 614.

Bus subsystem 612 provides a mechanism for letting the various components and subsystems of computing device 610 communicate with each other as intended. Although bus subsystem 612 is shown schematically as a single bus, alternative implementations of the bus subsystem 612 may use multiple busses.

Computing device 610 can be of varying types including a workstation, server, computing cluster, blade server, server farm, or any other data processing system or computing device. Due to the ever-changing nature of computers and networks, the description of computing device 610 depicted in FIG. 6 is intended only as a specific example for purposes of illustrating some implementations. Many other configurations of computing device 610 are possible having more or fewer components than the computing device depicted in FIG. 6.

In situations in which the systems described herein collect or otherwise monitor personal information about users, or may make use of personal and/or monitored information), the users may be provided with an opportunity to control whether programs or features collect user information (e.g., information about a user's social network, social actions or activities, profession, a user's preferences, or a user's current geographic location), or to control whether and/or how to receive content from the content server that may be more relevant to the user. Also, certain data may be treated in one or more ways before it is stored or used, so that personal identifiable information is removed. For example, a user's identity may be treated so that no personal identifiable information can be determined for the user, or a user's geographic location may be generalized where geographic location information is obtained (such as to a city, ZIP code, or state level), so that a particular geographic location of a user cannot be determined. Thus, the user may have control over how information is collected about the user and/or used.

In some implementations, a method implemented by processor(s) is provided and includes receiving an input query associated with a client device. The input query includes an input image and an input text query. The method further includes generating, from the input image and the input query, a plurality of image tiles. Each image tile is a sub-image of the input image. The method further includes providing, to one or more image analysis models, the plurality of image tiles. The method further includes receiving, from the one or more image analysis models, a plurality of image facts. Each image fact corresponds to a respective one or more of the image tiles. The method further includes generating, using a vision and language model, a response to the input query based on the input query, the plurality of image tiles, and the plurality of image facts. The method further includes causing the response to the input query to be rendered at the client device.

These and other implementations of the technology disclosed herein can include one or more of the following features.

In some implementations, the method further includes generating, using the vision and language model or a further vision and language model, one or more search requests based on the input query, the plurality of image tiles, and the plurality of image facts; providing, to a search engine, the one or more search requests; and receiving, from the search engine, one or more search responses to the one or more search requests. In some of those implementations generating, using the vision and language model, the response to the input query is further based on the one or more search responses.

In some implementations, generating, from the input image and the input query, the plurality of image tiles includes: inputting, into the vision and language model, the input image and the input query; processing the input image and the input query using the vision and language model to generate the plurality of image tiles; and outputting from the vision and language model, the plurality of image tiles.

In some implementations, generating, from the input image and the input query, the plurality of image tiles includes generating, from the input image and the input query, the plurality of image tiles using an object detection model.

In some implementations, providing, to the one or more image analysis models, the plurality of image tiles includes: determining, using the vision and language model, a classification for one or more of the plurality of image tiles; and providing each of the one or more image tiles to a respective one or more image analysis models in a plurality of image analysis models based at least in part on the respective image classification of the tile.

In some implementations, providing, to the one or more image analysis models, the plurality of image tiles includes providing the plurality of image tiles to the one or more image analysis models in parallel.

In some implementations, the plurality of image tiles include a plurality of bounding boxes, where each of the bounding boxes corresponds to a respective one or more objects in the input image. In some versions of those implementations, one or more of the image facts relate to one or more objects in a bounding box of the bounding boxes and/or one or more of the bounding boxes are rotated bounded boxes.

In some implementations, generating, using the vision and language model, the response to the input query includes sequentially inputting the plurality of image tiles and respective image facts into the vision and language model.

In some implementations, generating, using the vision and language model, the response to the input query comprises inputting the plurality of image tiles and respective image facts into the vision and language model in parallel.

In some implementations, the method further includes: generating, based on one or more of the image facts, one or more sub-tiles of an image tile; providing, to the one or more image analysis models, the one or more sub-tiles; and receiving, from the one or more image analysis models, one or more further image facts, each further image fact corresponding to a respective one or more of the sub-tiles. In some of those implementations, generating, using the vision and language model, the response to the input query is further based on the one or more further image facts.

In some implementations, generating, using a vision and language model, a response to the input query includes generating a natural language response to the input query and associating an element of the natural language response with a respective one or more portions of the input image. The respective one or more portions of the input image correspond to portions of the input image relevant to the element of the natural language response. In those implementations, causing the response to the input query to be rendered at the client device includes causing the natural language response to the input query to be rendered at the client device. Further, in some versions of those implementations the method can further include receiving an indication that the element of the natural language response has been selected at the client device and causing an indication of the respective one or more portions of the input image to be rendered at the client device. In some of those versions, the respective one or more portions of the input image include one or more image tiles. In some additional or alternative of those versions, the indication of the respective one or more portions of the input image includes one or more bounding boxes, where each bounding box corresponds to a respective image tile. In yet further additional or alternative of those versions, the method further includes receiving an indication that one or more of the respective one or more portions of the input image has been selected at the client device, and causing an indication of the element of the natural language response to be rendered at the client device.

In some implementations, generating, using a vision and language model, a response to the input query includes generating a natural language response to the input query and associating an element of the natural language response with a respective one or more portions of the input image. The respective one or more portions of the input image correspond to portions of the input image relevant to the element of the natural language response. In those implementations, causing the response to the input query to be rendered at the client device includes causing the natural language response to the input query to be rendered at the client device. Further, in some versions of those implementations the method can further include receiving an indication that one or more of the respective one or more portions of the input image has been selected at the client device and causing an indication of element of the natural language response to be rendered at the client device

In some implementations, receiving the input query associated with a client device includes receiving an initial input image that is at a first resolution and generating the input image from the initial input image, where the input image is at a second resolution that is lower than the first resolution.

In some implementations, a method implemented by processor(s) is provided and includes receiving an input query associated with a client device. The input query includes an input image and an input text query. The method further includes generating, from the input image and the input query, a plurality of image tiles. Each image tile is a sub-image of the input image. The method further includes generating, using a vision and language model, a response to the input query based on the input query and the plurality of image tiles, including: generating a natural language response to the input query based on the input query and the plurality of image tiles; and associating an element of the natural language response with a respective one or more portions of the input image. The respective one or more portions of the input image corresponding to portions of the input image relevant to the element of the natural language response. The method further includes causing the natural language response to the input query to be rendered at the client device, receiving an indication that the element of the natural language response has been selected at the client device, and causing an indication of the respective one or more portions of the input image to be rendered at the client device.

These and other implementations of the technology disclosed herein can include one or more of the following features.

In some implementations, the respective one or more portions of the input image include one or more image tiles. In some of those implementations, the indication of the respective one or more portions of the input image includes one or more bounding boxes, where each bounding box corresponds to a respective image tile.

In some implementations, the method further includes receiving an indication that one or more of the respective one or more portions of the input image has been selected at the client device and causing an indication of the element of the natural language response to be rendered at the client device.

Some implementations include an apparatus comprising one or more processors (e.g., CPU(s), GPU(s), and/or TPU(s)) and a memory, the memory storing computer readable instructions that, when executed by the one or more processors, cause the apparatus to perform any one of the methods disclosed herein. Some implementations include a transitory or non-transitory computer readable medium including computer-readable instructions that, when executed by one or more processors, cause the one or more processors to perform any one of the methods disclosed herein.

What is claimed is:

1. A method implemented by one or more processors, the method comprising:
receiving an input query associated with a client device, the input query comprising an input image and an input text query;
generating, from the input image and the input query, a plurality of image tiles, wherein each image tile is a sub-image of the input image;
providing, to one or more image analysis models, the plurality of image tiles;
receiving, from the one or more image analysis models, a plurality of image facts, each image fact corresponding to a respective one or more of the image tiles;
generating, using a vision and language model, a response to the input query based on the input query, the plurality of image tiles, and the plurality of image facts; and
causing the response to the input query to be rendered at the client device.

2. The method of claim 1, further comprising:
generating, using the vision and language model or a further vision and language model, one or more search requests based on the input query, the plurality of image tiles, and the plurality of image facts;
providing, to a search engine, the one or more search requests; and
receiving, from the search engine, one or more search responses to the one or more search requests,
wherein generating, using the vision and language model, the response to the input query is further based on the one or more search responses.

3. The method of claim 1, wherein generating, from the input image and the input query, the plurality of image tiles comprises:
inputting, into the vision and language model, the input image and the input query;
processing the input image and the input query using the vision and language model to generate the plurality of image tiles; and
outputting from the vision and language model, the plurality of image tiles.

4. The method of claim 1, wherein generating, from the input image and the input query, the plurality of image tiles comprises generating, from the input image and the input query, the plurality of image tiles using an object detection model.

5. The method of claim 1, wherein providing, to the one or more image analysis models, the plurality of image tiles comprises:
determining, using the vision and language model, a classification for one or more of the plurality of image tiles; and
providing each of the one or more image tiles to a respective one or more image analysis models in a plurality of image analysis models based at least in part on the respective image classification of the tile.

6. The method of claim 1, wherein providing, to the one or more image analysis models, the plurality of image tiles comprises providing the plurality of image tiles to the one or more image analysis models in parallel.

7. The method of claim 1, wherein the plurality of image tiles comprises a plurality of bounding boxes, each bounding box corresponding to a respective one or more objects in the input image.

8. The method of claim 7, wherein one or more of the image facts relate to one or more objects in a bounding box of the bounding boxes.

9. The method of any of claim 7, wherein one or more of the bounding boxes are rotated bounded boxes.

10. The method of claim 1, wherein generating, using the vision and language model, the response to the input query comprises sequentially inputting the plurality of image tiles and respective image facts into the vision and language model.

11. The method of claim 1, wherein generating, using the vision and language model, the response to the input query comprises inputting the plurality of image tiles and respective image facts into the vision and language model in parallel.

12. The method of claim 1, wherein the method further comprises:
generating, based on one or more of the image facts, one or more sub-tiles of an image tile;
providing, to the one or more image analysis models, the one or more sub-tiles; and
receiving, from the one or more image analysis models, one or more further image facts, each further image fact corresponding to a respective one or more of the sub-tiles,
wherein generating, using the vision and language model, the response to the input query is further based on the one or more further image facts.

13. The method of claim 1:
wherein generating, using a vision and language model, a response to the input query comprises:
generating a natural language response to the input query; and
associating an element of the natural language response with a respective one or more portions of the input image, the respective one or more portions of the input image corresponding to portions of the input image relevant to the element of the natural language response;
wherein causing the response to the input query to be rendered at the client device comprises causing the natural language response to the input query to be rendered at the client device; and
wherein the method further comprises:
receiving an indication that the element of the natural language response has been selected at the client device; and
causing an indication of the respective one or more portions of the input image to be rendered at the client device.

14. The method of claim 13, wherein the respective one or more portions of the input image comprise one or more image tiles.

15. The method of claim 14, wherein the indication of the respective one or more portions of the input image comprises one or more bounding boxes, each bounding box corresponding to a respective image tile.

16. The method of claim 13, wherein the method further comprises:
receiving an indication that one or more of the respective one or more portions of the input image has been selected at the client device; and
causing an indication of the element of the natural language response to be rendered at the client device.

17. The method of claim 1:
wherein generating, using a vision and language model, a response to the input query comprises:
generating a natural language response to the input query; and
associating an element of the natural language response with a respective one or more portions of the input image, the respective one or more portions of the input image corresponding to portions of the input image relevant to the element of the natural language response;
wherein causing the response to the input query to be rendered at the client device comprises causing the natural language response to the input query to be rendered at the client device; and
wherein the method further comprises:
receiving an indication that one or more of the respective one or more portions of the input image has been selected at the client device; and
causing an indication of element of the natural language response to be rendered at the client device.

18. The method of claim 1, wherein receiving the input query associated with a client device comprises:
receiving an initial input image that is at a first resolution; and
generating the input image from the initial input image, wherein the input image is at a second resolution that is lower than the first resolution.

19. A method implemented by one or more processors, the method comprising:
receiving an input query associated with a client device, the input query comprising an input image and an input text query;
generating, from the input image and the input query, a plurality of image tiles, wherein each image tile is a sub-image of the input image;
generating, using a vision and language model, a response to the input query based on the input query and the plurality of image tiles, comprising:
generating a natural language response to the input query based on the input query and the plurality of image tiles; and
associating an element of the natural language response with a respective one or more portions of the input image, the respective one or more portions of the input image corresponding to portions of the input image relevant to the element of the natural language response;
causing the natural language response to the input query to be rendered at the client device;
receiving an indication that the element of the natural language response has been selected at the client device; and
causing an indication of the respective one or more portions of the input image to be rendered at the client device.

20. The method of claim 19, wherein the respective one or more portions of the input image comprise one or more image tiles.

21. The method of claim 20, wherein the indication of the respective one or more portions of the input image comprises one or more bounding boxes, each bounding box corresponding to a respective image tile.

22. The method of claim 19, wherein the method further comprises:
receiving an indication that one or more of the respective one or more portions of the input image has been selected at the client device; and
causing an indication of the element of the natural language response to be rendered at the client device.
